(19) United States
(12) Patent Application Publication
(10) Pub. No.: US 2022/0271545 A1
(43) Pub. Date: Aug. 25, 2022

(54) COMBINED STORAGE CASE FOR ELECTRONIC DEVICE ACCESSORIES

(71) Applicant: Lucent Trans Electronic Co., Ltd., New Taipei City (TW)

(72) Inventor: Chin-Hung CHENG, New Taipei City (TW)

(73) Assignee: Lucent Trans Electronic Co., Ltd., New Taipei City (TW)

(21) Appl. No.: 17/181,368

(22) Filed: Feb. 22, 2021

(51) Int. Cl. H02J 7/00; H01R 35/04; H01R 13/518; H01R 31/06; H02G 11/02

(52) U.S. Cl. CPC H02J 7/0042; H01R 35/04; H01R 13/518; H01R 31/065; H02G 11/02; H01R 2103/00

(57) ABSTRACT

A combined storage case for electronic device accessories has a base case, a first case for receiving a transmission line or an earphone, and a power bank for charging an electronic device. The base case is provided with at least one first receptacle, a plug, and a car charger. An inner surface of the base case is provided with two first connecting parts. The first case is detachably connected with the base case via two second connecting parts. The power bank is detachably connected with the base case via two third connecting parts. The power bank and the base case engage with each other via a positioning recess and a position protrusion. The power bank and the first case are stably mounted on the base case by two magnetic elements attracting each other.

### BACKGROUND OF THE INVENTION

### 1. Field of the Invention

The present invention relates to a storage case, especially to a combined storage case for receiving electronic device accessories.

### 2. Description of the Prior Art(s)

Handheld electronic devices, such as personal digital assistants (PDAs), smartphones, tablet personal computers (tablet PCs), have become increasingly popular because of their portability and multiple functions they can perform. For instance, the handheld electronic devices can be connected to earphones to allow users to listen to music, can be connected to transmission lines to transmit data to computers, and also can be connected to chargers for charging. In order to perform the various functions, the user must carry the electronic device with the earphone, the transmission line, the charger or other electronic device accessories to the handheld electronic devices.

Generally, the electronic device accessories to the handheld electronic devices are put in the user's bag. However, the electronic device accessories are dispersedly disposed inside the bag so that a cord of the earphone and the transmission line will become entangled with each other. The entangled wires and lines are inconvenient for use. Besides, the electronic device accessories may be hidden by other objects inside the bag and thus it is inconvenient for the user to take out a needed accessory.

To overcome the shortcomings, the present invention provides a combined storage case for electronic device accessories to mitigate or obviate the aforementioned problems.

### SUMMARY OF THE INVENTION

The main objective of the present invention is to provide a combined storage case for electronic device accessories. The combined storage case has a base case, a first case for receiving a transmission line or an earphone, and a power bank for charging an electronic device. The base case is provided with at least one first receptacle, a plug, and a car charger. An inner surface of the base case is provided with two first connecting parts. The first case is detachably connected with the base case via two second connecting parts. The power bank is detachably connected with the base case via two third connecting parts. The power bank and the base case engage with each other via a positioning recess on a second case of the power bank and a position protrusion on the plug of the base case. The power bank and the first case are stably mounted on the base case by two magnetic elements embedded in the second case of the power bank and the first case respectively and attracting each other.

With the car charger and the plug plugged to a socket of domestic power, the base case may be used to charge an electronic device. When it is inconvenient for a user to reach the socket of domestic power and a power outlet in a car, the electronic device can be charged with the power bank. The transmission line or the earphone can be received in the first case 20, such that the transmission line or a wire of the earphone does not being entangled. Consequently, the combined storage case provides convenience for the user to take out a needed accessory and to store the accessories.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a combined storage case for electronic device accessories in accordance with the present invention;

FIG. 2 is an exploded perspective view of the combined storage case in FIG. 1;

FIG. 3 is another exploded perspective view of the combined storage case in FIG. 1;

FIG. 4 is a cross-sectional side view of the combined storage case in FIG. 1; and

FIG. 5 is an exploded perspective view of a second embodiment of a combined storage case for electronic device accessories in accordance with the present invention.

### DETAILED DESCRIPTION OF THE PREFERRED EMBODIMENTS

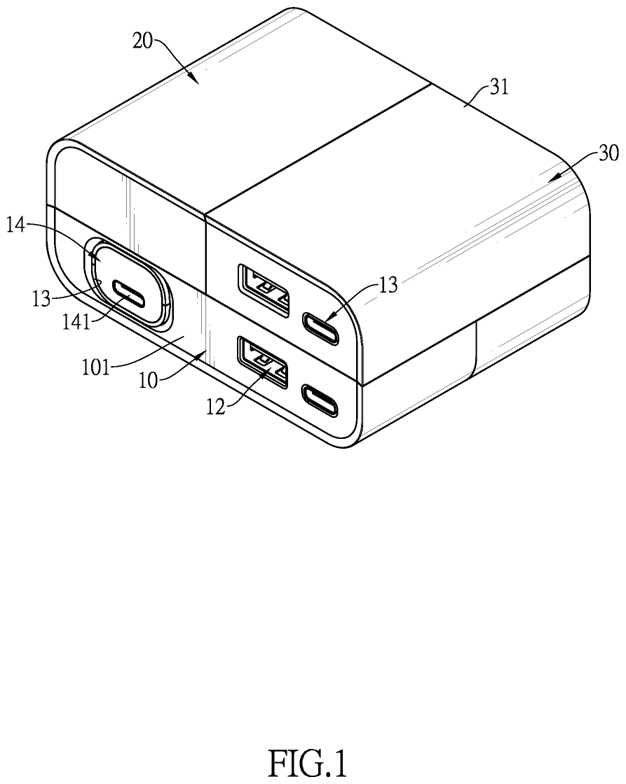

With reference to FIG. 1, a combined storage case for electronic device accessories in accordance with the present invention comprises a base case 10, a first case 20, and a power bank 30.

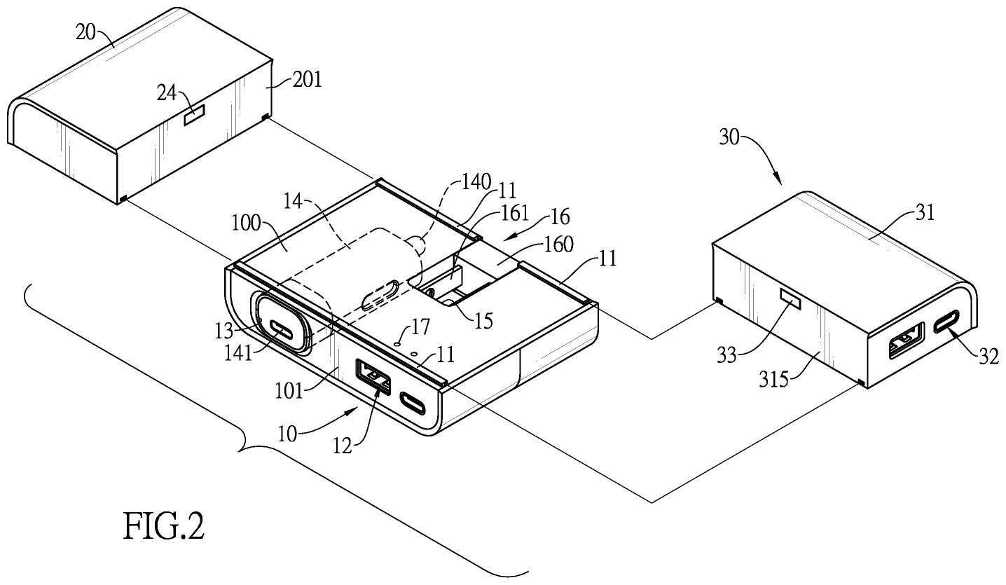

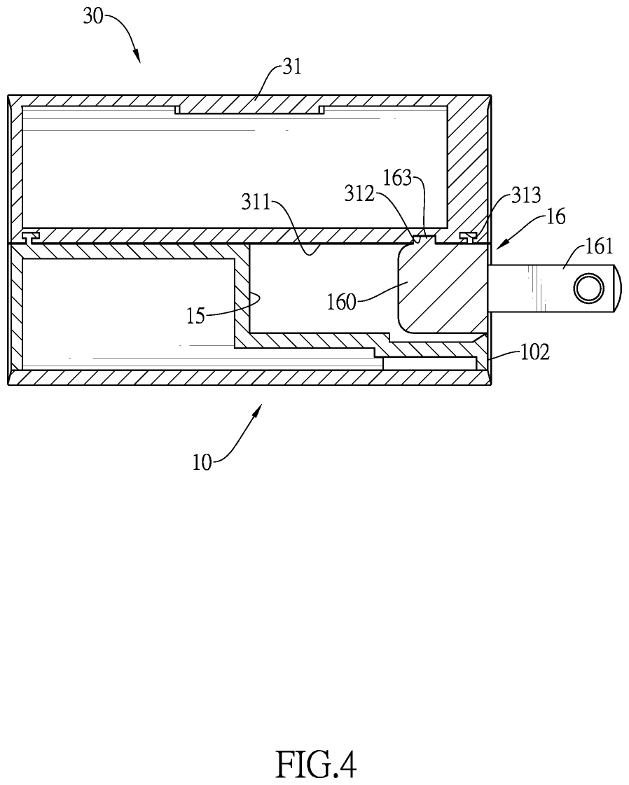

With further reference to FIGS. 2 and 4, the base case 10 is substantially cuboid in shape and has an inner surface 100, a first side surface 101, and a second side surface 102. The inner surface 100 is provided with two first connecting parts 11. The two first connecting parts 11 are formed on two opposite sides of the inner surface 100 respectively. One of the first connecting parts 11 is formed as an elongated protrusion that extends along an axis. The other first connecting part 11 is formed as two elongated protrusions that are separately disposed and both extend along an axis. The two axes of the two first connecting parts 11 are parallel with each other.

As shown in FIG. 2, the first side surface 101 of the base case 10 is adjacent to the inner surface 100 of the base case 10 and is provided with at least one first receptacle 12 and a mounting recess 13. An electronic device can be connected to one of the at least one first receptacle 12 with a built-in charging connector or an external power cable. When the at least one first receptacle 12 includes a plurality of first receptacles 12, the plurality of first receptacles 12 are different kinds of receptacles. In the preferred embodiment as shown in the figures, the at least one first receptacle 12 includes two first receptacles 12 and the two first receptacles 12 are a type-A Universal Serial Bus (USB) receptacle and a Type-C USB receptacle respectively. The mounting recess 13 is also formed in the first side surface 101 of the base case 10 and is mounted with a detachable car charger 14. The car charger 14 has two ends, a power connector 140, a second receptacle 141, and a transformer module. The power connector 140 of the car charger 14 is mounted on one end of the car charger 14 and is used to be connected with a power outlet of a car. The second receptacle 141 is mounted on the other end of the car charger 14 and is able to be connected to an electronic device. The transformer module of the car charger 14 is mounted inside the car charger 14, is electrically connected to the power connector 140 of the car charger 14 and the second receptacle 141. In the preferred embodiment as shown in the figures, the second receptacle 141 is Type-C USB receptacle.

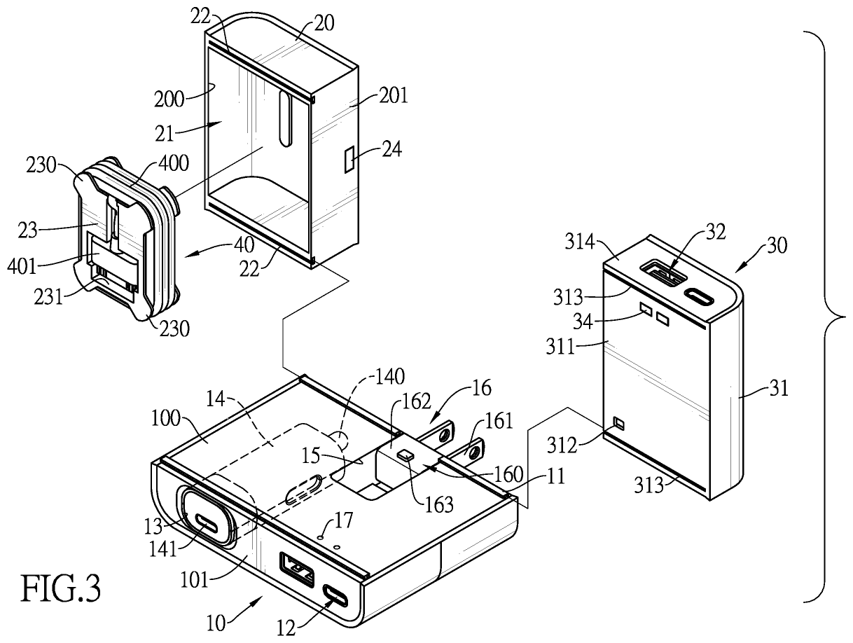

With reference to FIGS. 2 and 3, the second side surface 102 of the base case 10 is adjacent to the inner surface 100 of the base case 10, and the second side surface 102 of the base case 10 and the first side surface 101 of the base case 10 are oppositely defined on the base case 10. The second side surface 102 of the base case 10 is provided with a receiving recess 15. The receiving recess 15 is formed in the second side surface 102 of the base case 10 and through the inner surface 100 of the base case 10, is disposed between the two separated elongated protrusions of the first connecting part 11, and is provided with a plug 16. The plug 16 is pivotally mounted in the receiving recess 15 and has a rotary base 160 and two prongs 161. The rotary base 160 has two opposite side surfaces, a positioning surface 162, and a positioning protrusion 163. The two side surfaces of the rotary base 160 are pivotally connected to the base case 10. The positioning surface 162 is defined between the two side surfaces of the rotary base 160. The positioning protrusion 163 is formed on the positioning surface 162. The prongs 161 are separately mounted on the rotary base 160 and extend parallel with each other. When the plug 16 is rotated relative to the base case 10, the two prongs 161 are disposed in or protrude out of the receiving recess 15 selectively. A transformer module is mounted inside the base case 10 and is electrically connected to the two prongs 161 and the at least one first receptacle 12.

With reference to FIG. 3, the first case 20 is hollow, is substantially cuboid in shape, is detachably mounted on the base case 10, and has a connecting side surface 201, a mounting chamber 21, and two second connecting parts 22. The mounting chamber 21 is formed in the first case 20 and is defined through the first case 20 to form an opening 200. The second connecting parts 22 are formed oppositely beside the opening 200 and correspond in position to and are detachably connected with the two first connecting parts 11 respectively. Specifically, each of the second connecting parts 22 is formed as an elongated groove, such that the two second connecting parts 22 are slidably and detachably connected with the first connecting parts 11 respectively. Thus, the first case 10 is securely and detachably mounted on the inner surface 100 of the base case 10 and the opening 200 of first case 20 is covered by the inner surface 100 of the base case 10.

As shown in FIG. 3, the mounting chamber 21 of the first case 20 receives a reel 23. The reel 23 is formed as a block, is substantially cuboid in shape, and has a top surface, multiple positioning segments 230, and a positioning recess 231. The positioning segments 230 separately protrude from a peripheral sidewall of the reel 23. The positioning recess 231 is formed in the top surface of the reel 23. In the preferred embodiment as shown in the figures, the reel 23 is used for a wire 400 of a transmission line 40 of an electronic device to be wound thereon. The wire 400 that is wound on the reel 23 is held between the positioning segments 230. A plug 401 of the transmission line 40 can be put in the positioning recess 231 for storage. However, usage of the reel 23 is not limited as described above. The reel 23 may be designed for receiving an earphone.

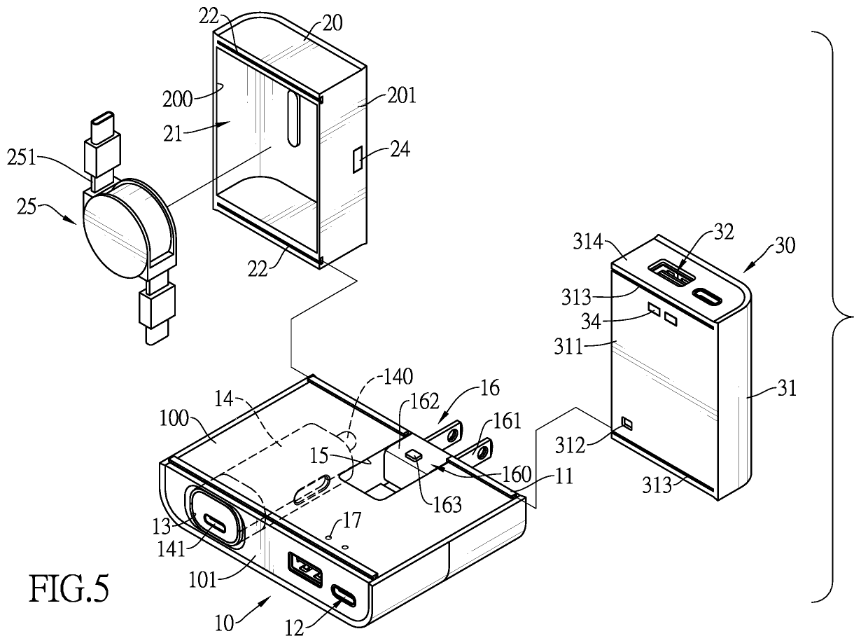

With further reference to FIG. 5, the mounting chamber 21 of the first case 20 may receive a retractable reel 25. A transmission line 251 is retractably wound around on the retractable reel 25, such that an extending length of the transmission line 251 can be adjusted according to a user's need.

The power bank 30 is detachably mounted on the base case 10 and has a second case 31, an electrical power storing module, and a charging/discharging module. The second case 31 has a combining surface 311, a side surface 314, and a connecting side surface 315. The combining surface 311 is provided with two third connecting part 313. The two third connecting parts 313 are formed on two opposite sides of the combining surface 311 respectively, and correspond in position to and are detachably connected with the two first connecting parts 11 respectively. Specifically, each of the third connecting parts 313 is formed as an elongated groove, such that the two third connecting parts 313 are slidably and detachably connected with the first connecting parts 11 respectively. Thus, the second case 31 is securely and detachably mounted on the inner surface 100 of the base case 10. The electrical power storing module and the charging/discharging module are mounted inside the second case 31 and are electrically connected with each other.

With further reference to FIGS. 3 and 4, the combining surface 311 of the second case 31 is provided with a positioning recess 312. When the plug 16 is rotated to allow the two prongs 161 to protrude out of the receiving recess 15, the positioning surface 162 of the rotary base 160 faces towards outside of the receiving recess 15. Meanwhile, if the power bank 30 is mounted on the base case 10, the positioning recess 312 on the combining surface 311 of the second case 31 of the power bank 30 engages with the positioning protrusion 163 on the positioning surface 162 of the rotary bas 160, so as to allow the power bank 30 to be stably mounted on the base case 10.

The side surface 314 of the second case 31 is provided with at least one third receptacle 32. The at least one third receptacle 32 is electrically connected to the charging/discharging module. An electronic device can be connected to one of the at least one third receptacle 32 with a built-in charging connector or an external power cable. When the at least one third receptacle 32 includes a plurality of third receptacles 32, the plurality of third receptacles 32 are different kinds of receptacles. In the preferred embodiment as shown in the figures, the at least one third receptacle 32 includes two third receptacles 32 and the two third receptacles 32 are a type-A USB receptacle and a Type-C USB receptacle respectively.

The connecting side surface 315 of the second case 31 faces toward the connecting side surface 201 of the first case 21. Two magnetic elements 33, 24 are embedded in the connecting side surface 315 of the second case 31 and the connecting side surface 201 of the first case 21 respectively. The magnetic element 33 on the connecting side surface 315 of the second case 31 corresponds in position to the magnetic element 24 on the connecting side surface 201 of the first case 21. Thus, when the power bank 30 and the first case 20 are both mounted on the base case 10, the two magnetic elements 24, 33 attract each other. Accordingly, the first case 20, the power bank 30, and the base case 10 can be firmly combined into one.

When charging an electronic device, the electronic device can be connected to one of the at least one first receptacle 12 with a built-in charging connector or an external power cable, the plug 16 is rotated to allow the two prongs 161 to protrude out of the base case 10, and the two prongs 161 are plugged to a socket of domestic power, so as to deliver electrical power to the electronic device for charging.

When the electronic device needs to be charged and the user is in a car, the car charger 14 can be taken out of the mounting recess 13, the power connector 140 of the car charger 14 is then plugged into the power outlet (e.g. a cigarette lighter receptacle) in the car and the built-in charging plug or the external power line of the electronic device is connected to the second receptacle 141 of the car charger 14. Thus, the electrical power can be delivered to the electronic device for charging.

In addition, when it is inconvenient for the user to reach the socket of domestic power and the power outlet in the car, the electronic device can be charged with the power bank 30 by being electrically connected to one of the at least one third receptacle 32 with the built-in charging connector or the external power cable.

Moreover, the combined storage case in accordance with the present invention allows the transmission line 40 or the earphone to be received in the first case 20, so that different electronic device accessories can be distinguished clearly to avoid confusion. The reel 23 and the retractable reel 25 can prevent the transmission line 40 or a wire of the earphone from being entangled. Consequently, the combined storage case provides convenience for the user to take out a needed accessory and to store the accessories.

Furthermore, with reference to FIG. 3, the inner surface 100 of the base case 10 is further provided with a base charging unit 17. The base charging unit 17 is electrically connected to the transformer module inside the base case 10. Preferably, the base charging unit 17 has two contacting protrusions. The combining surface 311 of the second case 31 of the power bank 30 is further provided with a power bank charging unit 34. The power bank charging unit 34 is electrically connected to the electrical power storing module of the power bank 30. Preferably, the power bank charging unit 34 has two contacting plates. When the power bank 30 is mounted on the base case 10, the power bank charging unit 34 is electrically connected to the base charging unit 17, so as to charge the power bank 30 with the electrical power with the domestic power through the plug 16 for the convenience of charging and using the power bank 30.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A combined storage case comprising:
a base case having
an inner surface provided with two first connecting parts and a receiving recess, and the two first connecting parts formed on two opposite sides of the inner surface respectively;
at least one first receptacle;
a mounting recess mounted with a detachable car charger; and
a plug pivotally mounted in the receiving recess and having
a rotary base having
two opposite side surfaces pivotally connected to the base case;
a positioning surface defined between the two side surfaces of the rotary base; and
a positioning protrusion formed on the positioning surface; and
two prongs separately mounted on the rotary base, wherein a transformer module is mounted inside the base case and is electrically connected to the two prongs and the at least one first receptacle;
a first case detachably mounted on the base case and having
a connecting side surface;
a mounting chamber formed in the first case and defined through the first case to form an opening; and
two second connecting parts formed oppositely beside the opening and corresponding in position to and are detachably connected with the two first connecting parts respectively, wherein when the first case is mounted on the base case, the opening of first case is covered by the inner surface of the base case; and
a power bank detachably mounted on the base case and having
a second case having
a combining surface provided with two third connecting part and a positioning recess, the two third connecting parts formed on two opposite sides of the combining surface respectively and corresponding in position to and detachably connected with the two first connecting parts respectively, and the positioning recess on the combining surface of the second case of the power bank engages with the positioning protrusion on the positioning surface of the rotary bas when the plug is rotated to allow the two prongs to protrude out of the receiving recess of the base case;
a side surface provided with at least one third receptacle; and
a connecting side surface facing toward the connecting side surface of the first case, wherein two magnetic elements are embedded in the connecting side surface of the second case and the connecting side surface of the first case respectively and attract each other when the power bank and the first case are both mounted on the base case;
an electrical power storing module mounted inside the second case and ; and
a charging/discharging module mounted inside the second case and electrically connected with the electrical power storing module and the at least one third receptacle.

2. The combined storage case as claimed in claim 1, wherein
one of the first connecting parts is formed as an elongated protrusion that extends along an axis, the other first connecting part is formed as two elongated protrusions that are separately disposed and both extend along an axis, and the two axes of the two first connecting parts are parallel with each other;
each of the second connecting parts of the first case is formed as an elongated groove, and the two second connecting parts are slidably and detachably connected with the first connecting parts respectively; and
each of the third connecting parts of the second case of the power bank is formed as an elongated groove, and the two third connecting parts are slidably and detachably connected with the first connecting parts respectively.

3. The combined storage case as claimed in claim 1, wherein the mounting chamber of the first case receives a reel, and the reel has
a top surface;
multiple positioning segments separately protrude from a peripheral sidewall of the reel; and
a positioning recess formed in the top surface of the reel.

4. The combined storage case as claimed in claim 2, wherein the mounting chamber of the first case receives a reel, and the reel has
a top surface;
multiple positioning segments separately protrude from a peripheral sidewall of the reel; and
a positioning recess formed in the top surface of the reel.

5. The combined storage case as claimed in claim 1, wherein the mounting chamber of the first case receives a retractable reel.

6. The combined storage case as claimed in claim 2, wherein the mounting chamber of the first case receives a retractable reel.

7. The combined storage case as claimed in claim 1, wherein the at least one first receptacle includes two first receptacles, and the two first receptacles are a type-A Universal Serial Bus (USB) receptacle and a Type-C USB receptacle respectively.

8. The combined storage case as claimed in claim 2, wherein the at least one first receptacle includes two first receptacles, and the two first receptacles are a type-A Universal Serial Bus (USB) receptacle and a Type-C USB receptacle respectively.

9. The combined storage case as claimed in claim 1, wherein the at least one third receptacle includes two third receptacles, and the two third receptacles are a type-A USB receptacle and a Type-C USB receptacle respectively.

10. The combined storage case as claimed in claim 2, wherein the at least one third receptacle includes two third receptacles, and the two third receptacles are a type-A USB receptacle and a Type-C USB receptacle respectively.

11. The combined storage case as claimed in claim 1, wherein
the inner surface of the base case is provided with a base charging unit, and the base charging unit is electrically connected to the transformer module inside the base case; and
the combining surface of the second case of the power bank is provided with a power bank charging unit, and the power bank charging unit is electrically connected to the electrical power storing module of the power bank;
wherein when the power bank is mounted on the base case, the power bank charging unit is electrically connected to the base charging unit.

12. The combined storage case as claimed in claim 2, wherein
the inner surface of the base case is provided with a base charging unit, and the base charging unit is electrically connected to the transformer module inside the base case; and
the combining surface of the second case of the power bank is provided with a power bank charging unit, and the power bank charging unit is electrically connected to the electrical power storing module of the power bank;
wherein when the power bank is mounted on the base case, the power bank charging unit is electrically connected to the base charging unit.
